(19) United States
(12) Patent Application Publication
(10) Pub. No.: US 2004/0226977 A1
(43) Pub. Date: Nov. 18, 2004

(54) Power-operated drive-in device

(76) Inventors: Thomas Hofbrucker, Mammendorf (DE); Manfred Ludwig, Landsberg (DE); Markus Looser, Weilheim (DE); Bernhard Liebert, Pfaffenhofen a.d. Glonn (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/775,810

(22) Filed: Feb. 9, 2004

(30) Foreign Application Priority Data
Feb. 7, 2003 (DE) 103 05 042.6

(51) Int. Cl. B25C 5/02

(52) U.S. Cl. 227/119

(57) ABSTRACT

A power-operated drive-in device (2) with a drive-in tool (13) for fasteners (15) and a head piece (4) which is arranged at an outlet opening (10) of a guide pipe (12) of the drive-in device (2) and has a holding device (44) that automatically receives and releases fasteners (15) which are fed to the head piece (4) via the guide pipe (12). The head piece (4) has a rotatable connection to the rest of the drive-in device (2).

### BACKGROUND OF THE INVENTION

The invention is directed to a power-operated drive-in device with a drive-in tool for fasteners and a head piece which is arranged at an outlet opening of a guide pipe of the drive-in device and has a holding device that automatically receives and releases fasteners which are fed to the head piece via the guide pipe.

Drive-in devices of the type mentioned above are often used for stand-up tools. With these stand-up tools, workpieces or structural component parts such as flat roof elements that are placed on the ground side or can be walked upon can be fastened or mounted by a person maintaining a substantially standing posture. For this purpose, the drive-in device is attached to a corresponding handle arrangement which is held during operation by the person operating the drive-in device. The retaining or holding device is opened and closed automatically when the drive-in device is pressed against the workpiece to be mounted and subsequently released again.

U.S. Pat. No. 5,897,045 shows a stand-up tool with a head piece in which the holding device is formed by a gripper mechanism. The gripper mechanism has two clamping jaws which are pretensioned respectively by a spring in a closed position in which they initially hold a fastener to be driven in. When the head piece is pressed against a workpiece, the clamping jaws are swiveled apart and accordingly release a fastener, previously retained therein, for driving in by a tool.

A holding device of the type mentioned above has the disadvantage that the head piece does not have any circular cross section transverse to the driving-in direction, but rather has a cross section with a relatively large cross-sectional length in the swiveling direction of the clamping jaws and a small cross-sectional width perpendicular thereto. As a result, when mounting profiled workpieces such as corrugated sheet metal which must generally be fastened at the profile troughs, the head piece can come into contact with a profile trough only when its cross-sectional length is oriented in longitudinal direction of the profile. For this reason, orientation of the stand-up tool relative to the profile is predetermined in many cases. Therefore, an operator often faces the difficulty of having to move sideways when mounting a series of fasteners on a profiled workpiece. This can present a considerable impediment to work precisely in workpieces covering a large area as is often the case with flat roofs.

### SUMMARY OF THE INVENTION

It is the object of the present invention to overcome the disadvantages mentioned above and to ensure greater ease of operation in a stand-up tool with a non-circular cross section.

According to the invention, this object is met by a head piece that is rotatable relative to the rest of the drive-in device. This makes it possible for the operator of a stand-up tool to orient the head piece in the desired manner relative to the handle arrangement. In so doing, the operator will generally orient the head piece such that the fastener can always be driven in while the operator walks in a straight line. Work is considerably facilitated in this way precisely with long rows of fasteners to be placed one behind the other on profiled workpieces and with alternating orientation of the rows.

It is advantageous when the head piece can be rotated relative to the rest of the drive-in device into at least two fixing positions. The fixing positions make it possible to determine in advance the most practical or anticipated required orientations of the head piece relative to the rest of the drive-in device during prescribed use of the drive-in device and to change comfortably between them.

The fixing positions preferably enclose a swiveling angle of about 90°. Accordingly, the operator can easily change between a first running direction on a profiled workpiece and a second running direction orthogonal to the first running direction. This ensures easy switching between the required orientations of the head piece for normal applications of a stand-up tool, namely, mounting in longitudinal and transverse direction of a profile.

In a preferred embodiment, the drive-in device has a locking device for fixing the head piece relative to the rest of the drive-in device. This locking device has, at the head piece, at least one opening into which a locking body is guided. The locking body is acted upon by a force which presses it against the guide pipe. At least two receptacles with which the locking body can engage in a snap-in connection are formed at the guide pipe. In this way, the head piece can be reliably and detachably fixed relative to the rest of the drive-in device in a simple manner and the head piece is prevented from rotating in an unwanted manner relative to the rest of the drive-in device.

The locking body is advantageously formed by a ball. Through the use of a spherical shape, the locking body can be moved into and out of engagement with the receptacles in a simple manner such that good adjustability of the locking device is achieved.

The locking body is advantageously pressed against the guide pipe by a leaf spring. The application of pressure to the locking body is carried out in a very simple and economical manner by the leaf spring. In addition, by using this method, it is possible, when needed, to change the forces required for adjusting the locking device by exchanging the leaf spring.

In an alternative embodiment, the drive-in device has a locking device with a locking screw. In order to lock the head piece to be fixed with respect to rotation relative to the rest of the drive-in device, the locking screw is displaced by the end remote of the screw head through a screw receptacle formed at the head piece into one of at least two bore holes formed at the guide pipe. The screw receptacle or the bore hole has a thread corresponding to the locking screw. This affords another simple and reliable possibility for fixing the head piece in a determined orientation relative to the rest of the drive-in device and a handle arrangement connected to the latter.

Further, it is advantageous that the drive-in device has an axial securing device with a retaining pin which is held in a receiving bore hole of the head piece transverse to the drive-in direction when the head piece is fixed to the rest of the drive-in device. The retaining pin projects partially into an annular groove that is formed at the guide pipe transverse to the drive-in direction. In this way, an axial securing device which fixes the head piece securely to the guide pipe, and therefore to the rest of the drive-in device, in the drive-in direction and which simultaneously allows unobstructed rotation of the head piece relative to the rest of the drive-in device along the annular groove is achieved in a simple manner.

### BRIEF DESCRIPTION OF THE DRAWINGS

The invention will be described more fully in the following with reference to the drawings wherein:

FIG. 1 shows a longitudinal section through a stand-up tool with a drive-in device according to the invention;

FIG. 2 shows a view of the tool-side end of the drive-in device according to the invention;

FIG. 3 shows a longitudinal section through the tool-side end of FIG. 2;

FIG. 4 shows a cross section through a locking device of the drive-in device of FIG. 2;

FIG. 5 shows a view of the drive-in device of FIG. 2 with the head piece rotated 90°;

FIG. 6 shows a view of a drive-in device with an alternative locking device; and

FIG. 7 shows a cross section through the alternative locking device of FIG. 6.

### DETAILED DESCRIPTION OF THE INVENTION

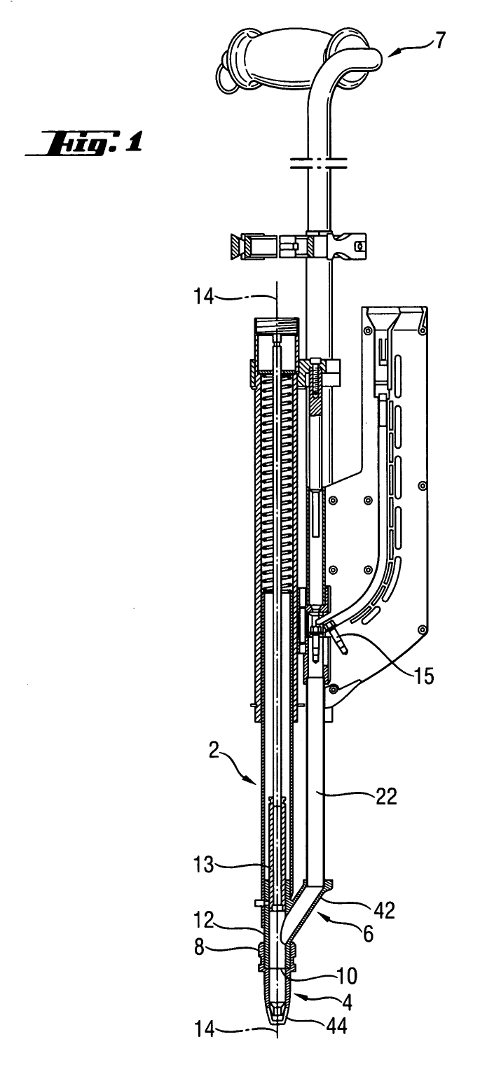

FIGS. 1 to 7 show a tool-side end of a drive-in device 2 according to the invention. This drive-in device 2 has a head piece 4 which is arranged at a Y-shaped pipe arrangement 6. As can be seen from FIG. 1, the drive-in device 2 is to be used for a stand-up tool. For this purpose, a handle arrangement 7 which allows the operator to actuate the drive-in device 2 while maintaining a substantially upright posture is arranged at the end of the drive-in device 2 remote from the head piece 4.

The head piece 4 has a collar 8 which is placed on a guide pipe 12 of the pipe arrangement 6 at an outlet opening 10. A drive-in tool 13 is guided along a drive-in axis 14 in the guide pipe 12. Fasteners 15 such as screws, bolts or rivets can be driven into a workpiece with this drive-in tool 13.

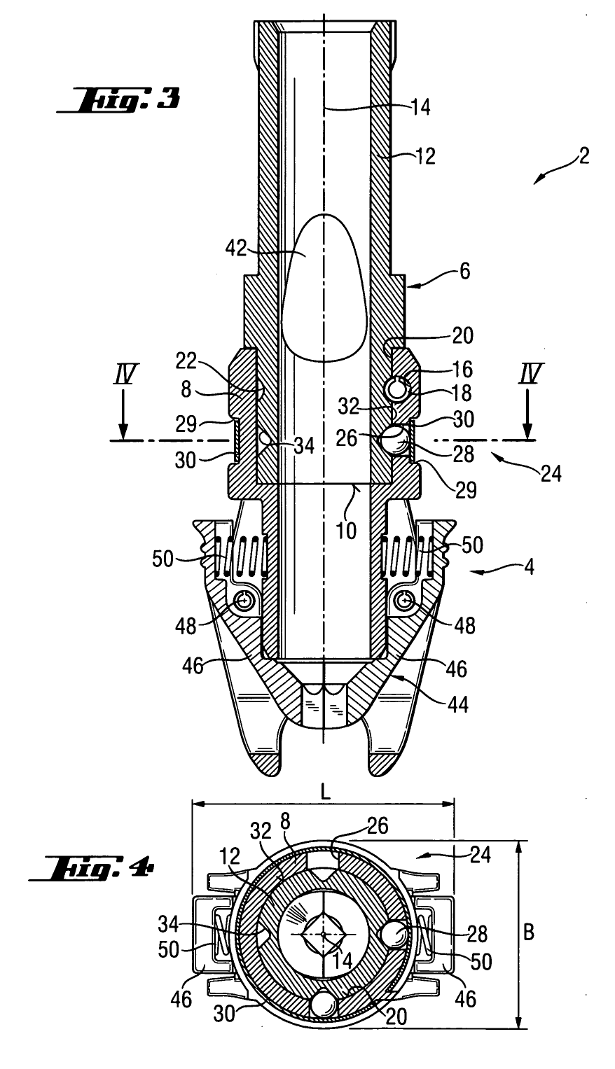

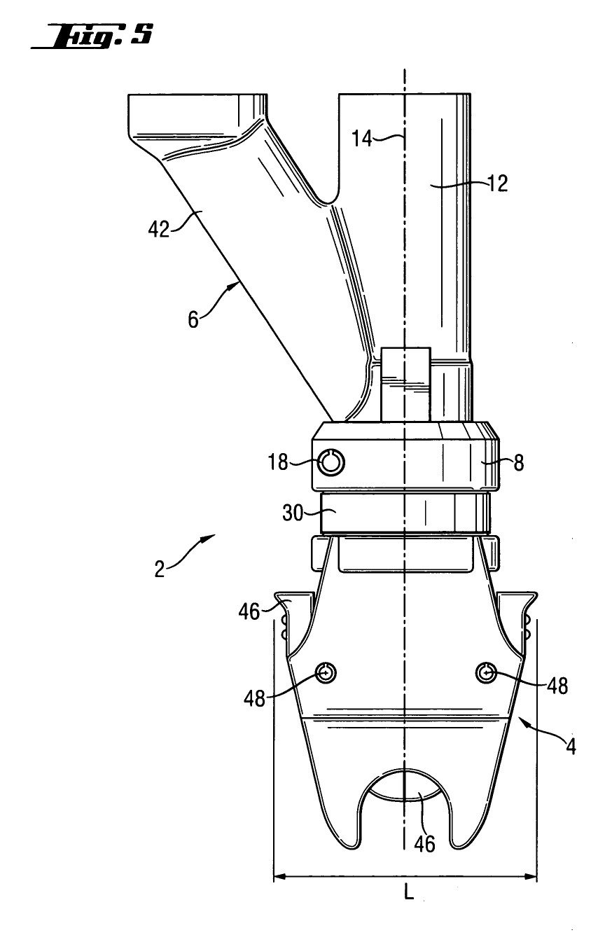

A receiving bore hole 16 in which a retaining pin 18 is received (see FIGS. 3 and 5) is constructed at the collar 8 transverse to the drive-in axis 14. The receiving bore hole 16 is constructed such that it penetrates an inner wall 20 of the collar 8. For this reason, the retaining pin 18 which is inserted into the receiving bore hole 16 projects inward partially beyond the inner wall 20. In the axially secured arrangement of the head piece 4 relative to the pipe arrangement 6 shown in the drawing, an annular groove 22 is formed at the guide pipe 12 at the height at which the receiving bore hole 16 penetrates the inner wall 20. The retaining pin 18 supported in the receiving bore hole 16 projects through it into the annular groove 22 and accordingly prevents axial displacement of the head piece 4 relative to the guide pipe 12 in direction of the drive-in axis. On the other hand, it is possible for the retaining pin 18 to be displaced with the head piece 4 along the annular groove 22, which results in a rotation of the head piece 4 around the drive-in axis 14 relative to the pipe arrangement 6.

Further, a locking device 24 by which the head piece 4 can be locked at the pipe arrangement 6 to be fixed with respect to rotation relative to it is arranged at the collar 8. As can be seen particularly from FIGS. 3 and 4, the collar 8 has cylindrical openings 26 in which a spherical locking body 28 is held so as to be displaceable radially with respect to the drive-in axis 14. Further, a neck down portion 29 is formed at the height of the openings 26 around the collar 8. A leaf spring 30 which is formed in a slotted cylinder is inserted into this neck down portion 29. This leaf spring 30 presses the locking body 28 inward into the openings 26 in a direction of the guide pipe 12. Trough-shaped receptacles 34 are formed at an outer side 32 of the guide pipe 12, the locking body 28 projecting into the receptacles 34 in the locked state of the head piece 4 depicted in the drawing. In this way, the locking body 28 with the leaf springs 30 and the receptacles 34, form a catch connection or snap-in connection which prevents unwanted rotation of the head piece 4 relative to the rest of the drive-in device 2.

In the embodiment of FIG. 4, the locking device 24 has four receptacles 34 which are arranged at a distance of 90° around the drive-in axis 14. Aside from this arrangement, any other reasonable and suitable quantity and spacing of the receptacles 34 is also possible.

The spring characteristic of the leaf spring 30 is selected such that a person operating the drive-in device can cause the locking body 28 to be moved out of the receptacles 34 with a reasonable amount of force by applying torque to the head piece 4 to catch in a respective neighboring receptacle 34.

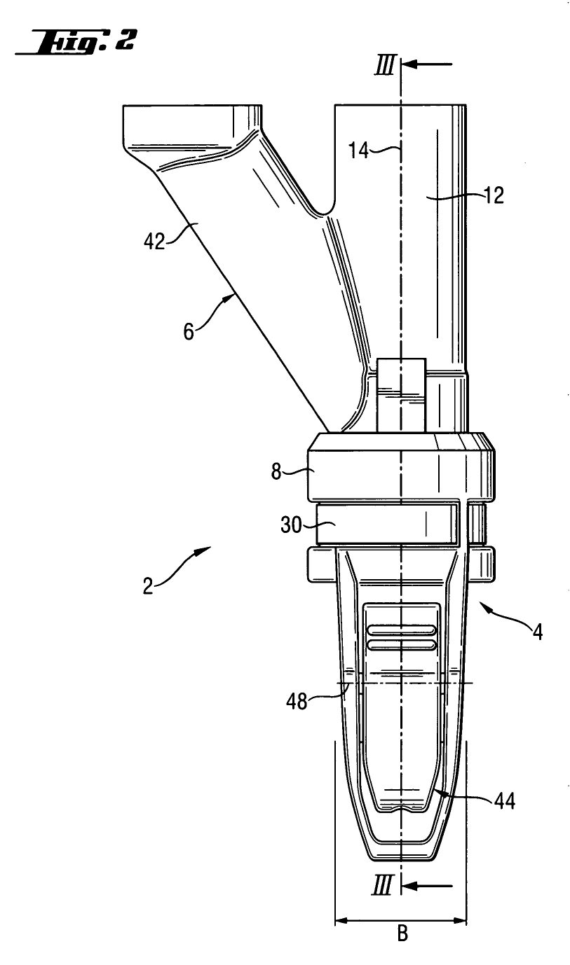

FIG. 5 shows the drive-in device of FIG. 2 after such a rotation of the head piece 4 relative to the pipe arrangement 6 and relative to the rest of the drive-in device 2. Compared to a first fixing position of the head piece 4 according to FIG. 2, the head piece 4 in FIG. 5 has a second fixing position in which the head piece is oriented to be rotated by 90° relative to the pipe arrangement 6.

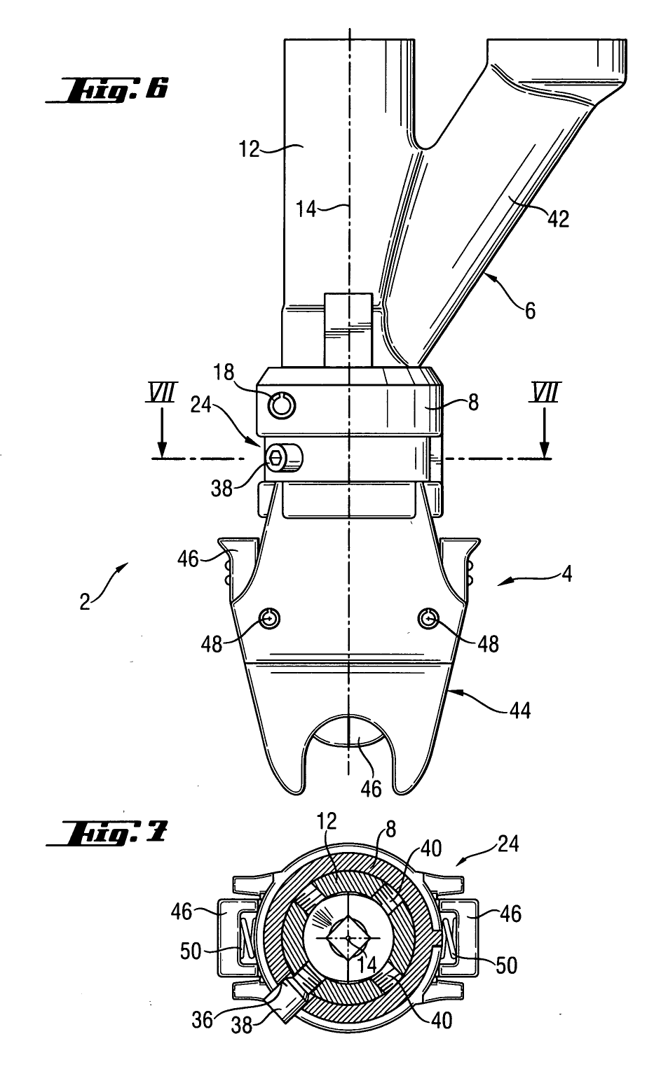

FIGS. 6 and 7 show an alternative locking device 24. Corresponding elements are designated by corresponding reference numbers as in FIGS. I to 5. The alternative locking device 24 has, at the collar 8, a screw receptacle 36 in which a locking screw 38 can be introduced. In the axially fixed state of the head piece 4, a plurality of radially arranged bore holes 40 are arranged at the height of the screw receptacle 36 in this locking device 24. The locking screw 38 can be placed through the screw receptacle 36 by an end remote of the screw head into one of the bore holes 40. In this way, the locking screw 38 blocks a rotation of the head piece 4 relative to the guide pipe 12. In order to change the orientation of the head piece 4 relative to the pipe arrangement 6, the locking screw 38 is removed from the bore hole 40 and screwed into one of the other bore holes 40.

In the embodiment of FIG. 7, the alternative locking device 24 has four bore holes 40 which are arranged at a distance of 90° around the drive-in axis 14. Aside from this arrangement, any other sensible and suitable quantity and spacing of the bore holes 40 can also be carried out.

In order to drive in the fasteners 15, the latter slide individually from a fall pipe 42 of the pipe arrangement 6 into the guide pipe 12 and then slide along the drive-in axis 14 to a holding device 44 of the head piece 4. The holding device 44 has a pincer arrangement with two clamping jaws 46 which swivel around an axis 48. The two clamping jaws 46 are each pretensioned in the closing position of the pincer arrangement by a helical spring 50. In the swiveling direction of the clamping jaws 46, the pincer arrangement has a cross-sectional length L which is appreciably greater than a cross-sectional width B extending transverse thereto.

Before a fastener 15 is driven in, it is held between the clamping jaws 46. As soon as the operator presses the drive-in device 2 down against a workpiece, e.g., a flat roof element, by the handle arrangement 7, the drive-in tool 13 acts at the fastening element while the clamping jaws 46 are triggered by the pressure on the drive-in device 2 to swivel automatically toward the side. As soon as the operator removes pressure from the drive-in device 2, the clamping jaws 46 are pressed together again by the helical spring 50 and clamp between them a new fastening element that has slid down from the guide pipe 42 in the meantime.

In this way, it is possible for the operator to apply a plurality of fasteners 15 to one or more workpieces that can be walked upon, e.g., flat roof elements, in a comfortable manner, namely, in a standing or walking position.

Workpieces of the type mentioned above often have a profile such as a corrugated profile. Often, these profiles are dimensioned such that the head piece 4 fits between two neighboring profile crests only when the cross-sectional length L of the head piece 4 is oriented in the profile direction, i.e., in the orientation of its profile troughs or profile crests. Consequently, it is possible to drive in the fastener 15 at a profile trough only when the head piece 4 is oriented in this way.

When the operator must change from a mounting direction in the profile direction to a mounting direction transverse to the profile direction while mounting a workpiece that is profiled in the manner described above, it is now possible for the operator to rotate the head piece 4 from a first fixing position by 90° relative to the rest of the drive-in device and handle arrangement into a second fixing position. In this way, even when the mounting direction changes with respect to the profile direction of the workpiece, the operator can always orient the head piece 4 such that the cross-sectional length L of the head piece 4 is always in the profile direction so that it is only necessary that the narrower cross-sectional width fits between the profile crests to be able to drive in a fastener 15 at the profile trough.

What is claimed is:

1. A power-operated drive-in device (2) with a drive-in tool (13) for fasteners (15) and with a head piece (4) arranged at an outlet opening (10) of a guide pipe (12) of the drive-in device (2) and having a holding device (44) that automatically receives and releases fasteners (15) that are fed to the head piece (4) via the guide pipe (12), wherein the head piece (4) has a rotatable connection to the rest of the drive-in device (2).

2. The power-operated drive-in device of claim 1, wherein the head piece (4) has at least two fixing positions relative to the rest of the drive-in device (2).

3. The power-operated drive-in device of claim 2, wherein the fixing positions enclose a swiveling angle of substantially 90°.

4. The power-operated drive-in device of claim 3, wherein the drive-in device has a locking device (24) having at least one opening (26) at the head piece (4) in which a locking body (28) is held in a movable manner, the locking body (28) being pressed against the guide pipe (12) wherein at least two receptacles (34) with which the locking body (28) can engage.

5. The power-operated drive-in device of claim 4, wherein the locking body (28) is a ball.

6. The power-operated drive-in device of claim 4, wherein the locking body (28) is acted upon by pressure in a direction of the guide pipe (12) through a leaf spring (30).

7. The power-operated drive-in device of claim 3, wherein the drive-in device (2) has a locking device (24) with a locking screw (38) that can be positioned in one of at least two bore holes (40) at the guide pipe (12) by an end remote of the screw head through a screw receptacle (36) of the head piece (4).

8. The power-operated drive-in device of claim 7, wherein the drive-in device (2) has an axial securing device with a retaining pin (18) that is arranged in a receiving bore hole (16) of the head piece (4) transverse to the drive-in direction (14) when the head piece (4) is fixed to the rest of the drive-in device (2) and the retaining pin (18) projects partially into an annular groove (22) that is formed at the guide pipe (12) transverse to the drive-in axis (14).
